(19) United States
(12) Patent Application Publication
(10) Pub. No.: US 2007/0171355 A1
(43) Pub. Date: Jul. 26, 2007

(54) Polarizer and display apparatus having the same

(75) Inventor: Dong-Hoon Chung, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/545,994

(22) Filed: Oct. 10, 2006

(30) Foreign Application Priority Data
Jan. 26, 2006 (KR) 2006-8031

(51) Int. Cl. G02F 1/13

(52) U.S. Cl. 349/194

(57) ABSTRACT

A polarizer includes a polarizing element, a first protective layer and a second protective layer and a surface treatment layer. The first and the second protective layer are formed on opposing sides of the polarizing element. The surface treatment layer is formed on the first protective layer and includes at least two kinds of scattering materials having different refraction indexes from each other. An inside haze value by the scattering materials is in a range of about 25% to about 50%. An outside haze value at the surface of the surface treatment layer is in a range of about 0.1% to about 1%.

### CROSS-REFERENCE TO RELATED APPLICATIONS

This application claims priority to Korean Patent Application No. 2006-8031 filed on Jan. 26, 2006 under 35 USC Section 119, the contents of which are herein incorporated by reference in their entirety.

### BACKGROUND OF THE INVENTION

1. Technical Field

The present disclosure relates to a polarizer and a display apparatus having the polarizer. More particularly, the present invention relates to a polarizer capable of improving color reproducibility and a surface hardness and a display apparatus having the polarizer.

2. Discussion of the Related Art

In general, a liquid crystal display (LCD) apparatus includes an LCD panel having a thin film transistor substrate, a color filter substrate and a liquid crystal layer disposed between the two substrates.

An upper polarizer and a lower polarizer are respectively disposed on the LCD panel and under the LCD panel. The lower polarizer polarizes an incident light into the LCD panel, and the upper polarizer polarizes an exiting light that exits from the LCD panel.

A surface treatment layer is formed on a surface of the upper polarizer to prevent dazzling. A conventional surface treatment layer is formed by dispersing and spreading silica particles onto a resin such as an acrylate, and has a high haze value to prevent a reflection of the external light generated from a light source such as a fluorescent lamp. However, the high haze value deteriorates color quality such that the color of an image appears different from the original color. Further, the surface of the polarizer is relatively soft, at about 3 H level pencil hardness. Such surface can be scratched or damaged easily from an external impact.

### SUMMARY OF THE INVENTION

Embodiments of the present invention provide a polarizer capable of improving color reproducibility and surface hardness, and a display apparatus having the above-mentioned polarizer.

In an exemplary embodiment of the present invention, a polarizer includes a polarizing element, a first protective layer, a second protective layer and a surface treatment layer. The first and the second protective layers are formed on both sides of the polarizing element, respectively. The surface treatment layer is formed on the first protective layer and includes at least two kinds of scattering materials having different refraction indexes from each other.

An inside haze value by the scattering materials may be in a range of about 25% to about 50%.

Moreover, an outside haze value at a surface of the surface treatment layer may be in a range of about 0.1% to about 1%.

The scattering materials may include scattering particles having a first refraction index and air bubbles having a second refraction index smaller than the first refraction index. For example, each of the air bubbles may surround each of the scattering particles.

The scattering particles may include silica, and the size of the scattering particles may be in a range of about 3 μm to about 5 μm.

A thickness of the surface treatment layer may be in a range of about 4 μm to about 6 μm.

Moreover, the first and second protective layers may include tri-acetyl cellulose (TAC) film.

The polarizer may further include an electrostatic protective layer formed between the first protective layer and the surface treatment layer.

In an exemplary embodiment of the present invention, a display apparatus includes a display panel, a first polarizer and a second polarizer. The display panel displays an image and includes a first substrate, a second substrate facing the first substrate and a liquid crystal layer disposed between the first substrate and the second substrate. The first polarizer is disposed on an outer surface of the first substrate. The second polarizer is disposed on an outer surface of the second substrate and includes at least two kinds of scattering materials having the different refraction indexes from each other.

### BRIEF DESCRIPTION OF THE DRAWINGS

Exemplary embodiments of the present invention can be understood in more detail from the following descriptions taken in conjunction with the accompanying drawings, in which:

FIG. 1 is a plan view illustrating a display apparatus in accordance with an embodiment of the present invention;

FIG. 2 is a plan view illustrating a second polarizer of FIG. 1;

FIG. 3 is a cross-sectional view illustrating a second polarizer in accordance with an embodiment of the present invention; and

FIG. 4 is a cross-sectional view illustrating a second polarizer in accordance with an embodiment of the present invention.

### DESCRIPTION OF EXEMPLARY EMBODIMENTS

Exemplary embodiments of the invention are described more fully hereinafter with reference to the accompanying drawings, in which embodiments of the invention are shown. This invention may, however, be embodied in many different forms and should not be construed as limited to the embodiments set forth herein. It will be understood that when an element or layer is referred to as being “on,” “connected to” or “coupled to” another element or layer, it can be directly on, connected or coupled to the other element or layer or intervening elements or layers may be present. Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

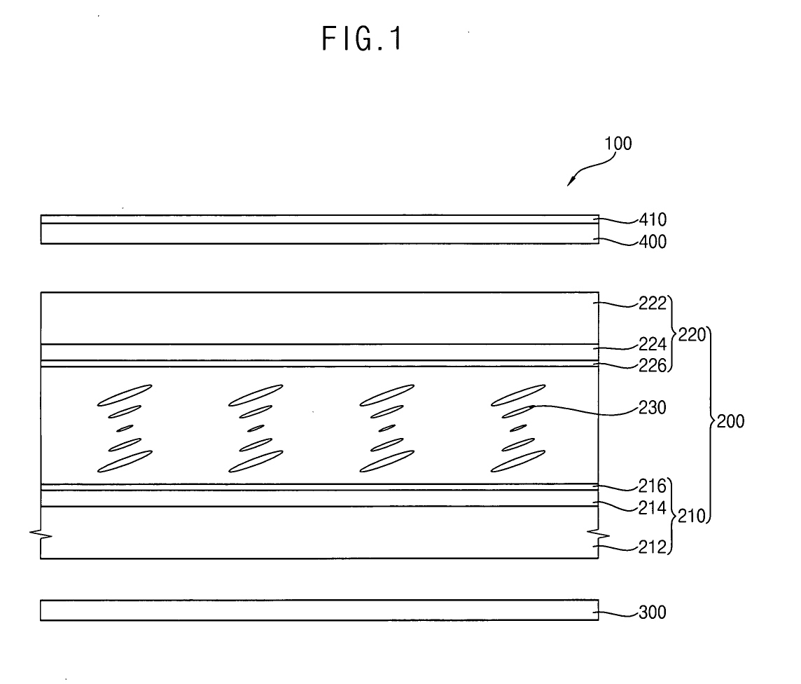

FIG. 1 is a plan view illustrating a display apparatus in accordance with an exemplary embodiment of the present invention.

Referring to FIG. 1, a display apparatus 100 in accordance with an exemplary embodiment of the present invention includes a display panel 200, a first polarizer 300 and a second polarizer 400. The display panel 200 displays an image, and the first polarizer 300 is disposed under the display panel 200. The second polarizer 400 is disposed on the display panel 200.

The display panel 200 includes a first substrate 210, a second substrate 220 facing the first substrate 210 and a liquid crystal layer 230 disposed between the first substrate 210 and the second substrate 220.

The first substrate 210 includes a thin film transistor substrate having an insulation substrate 212, a pixel layer 214 and a pixel electrode 216, in sequence. The pixel layer 214 includes a plurality of thin film transistors arranged in a matrix.

The second substrate 220 includes a color filter substrate. The color filter substrate includes an insulation substrate 222, a color filter 224 on the insulation substrate 222 and a common electrode 226. The color filter 224 transmits light having a predetermined wavelength to display a color image. The common electrode 226 faces the pixel electrode 216 of the first substrate 210. Alternatively, the color filter 224 may be formed on the first substrate 210.

The pixel electrode 216 and the common electrode 226 include transparent conductive material to transmit an incident light that is from outside of the display panel 200. For example, the pixel electrode 216 and the common electrode 226 may include indium tin oxide (ITO) or indium zinc oxide (IZO).

The liquid crystal layer 230 includes liquid crystals having optical and electronical characteristics such as anisotropic refraction, anisotropic permittivity and so on. The liquid crystals of the liquid crystal layer 230 may be arranged in a predetermined direction. For example, the liquid crystal layer 230 may include nematic liquid crystals. The arrangement of the liquid crystal layer 230 is changed by an electric field formed between the pixel electrode 216 and the common electrode 226, and the change of the arrangement of the liquid crystals controls the transmissivity of the light passing through the liquid crystal layer 230.

The first polarizer 300 is disposed under the display panel 200. For example, the first polarizer 300 is on an outer surface of the first substrate 210. The first polarizer 300 transmits the light vibrating in a predetermined polarizing axis, and blocks the light vibrating in different directions. Therefore, the first polarizer 300 polarizes the incident light that is emitted from a backlight assembly. The backlight assembly is disposed under the first polarizer 300. The first polarizer 300 may be attached to the first substrate 210 by an adhesive or an adhesive tape.

The second polarizer 400 is disposed on the display panel 200. For example, the second polarizer 400 is on an outer surface of the second substrate 220. The second polarizer 400 transmits the light vibrating in a predetermined polarizing axis, and blocks the light vibrating in different directions. Therefore, the second polarizer 400 polarizes the incident light having passed through the liquid crystal layer 230 of the display panel 200. The second polarizer 400 may be attached to the second substrate 220 by an adhesive or an adhesive tape.

The polarizing axis of the first polarizer 300 and the polarizing axis of the second polarizer 400 may change. For example, the polarizing axis of the first polarizer 300 and the polarizing axis of the second polarizer 400 may be substantially in perpendicular to each other. The two polarizing axes also may form an acute angle, and the two polarizing axes may also be substantially in parallel with each other.

A surface treatment layer 410 is formed on an exposed surface of the second polarizer 400. The haze value of the surface treatment layer 410 may be increased to prevent the dazzling. However, when the haze value recognized at the surface of the surface treatment layer 400 is too high, color reproducibility of the display apparatus 100 may be deteriorated. In FIG. 1, the surface roughness of the surface treatment layer 400 is increased, and the haze of the outside surface is decreased, so that the color reproducibility is improved.

In FIG. 1, the surface treatment layer 400 includes at least two kinds of scattering materials having different refractive indexes so that the haze value of the surface treatment layer 400 may increase. Thereby, high haze value may be obtained with a low density of the scattering materials using at least two kinds of the scattering materials, than using only one kind of scattering material. Moreover, the density of the scattering material is lowered, so that the surface roughness and the surface hardness are improved.

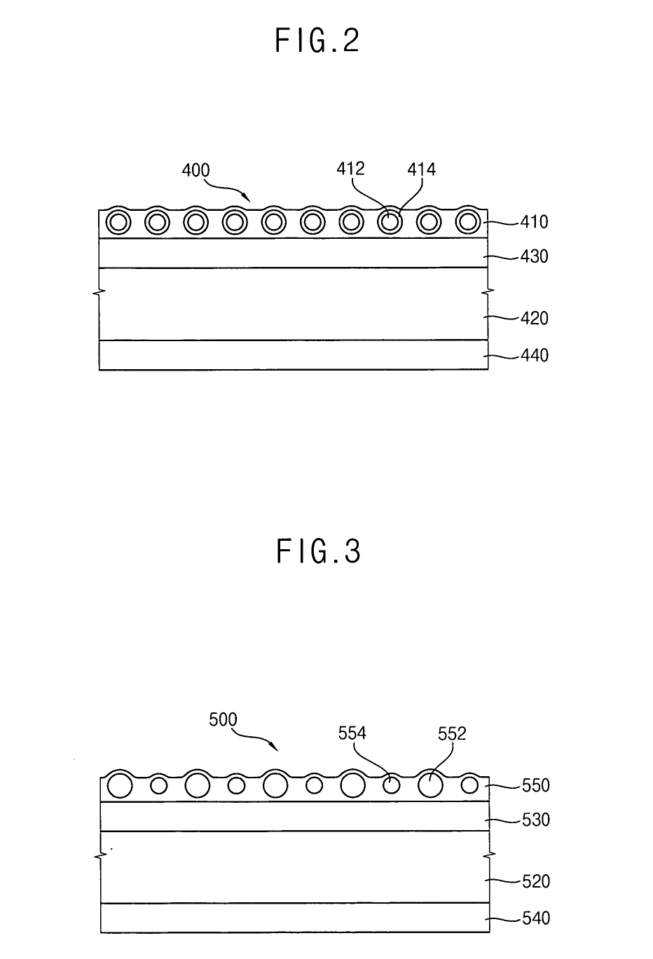

FIG. 2 is a plan view illustrating a second polarizer of FIG. 1.

Referring to FIG. 2, the second polarizer 400 includes a polarizing element 420, a first protective layer 430, a second protective layer 440 and a surface treatment layer 410. The polarizing element 420 is disposed between the first protective layer 430 and the second protective layer 440, and the surface treatment layer 410 is disposed on the first protective layer 430.

The polarizing element 420 polarizes the light incident into the polarizing element 420. For example, the polarizing element 420 may include poly vinyl alcohol (PVA). A poly vinyl alcohol film is extended and dipped in a solution of iodine (I₂) and dichromatic dye, so that the iodine molecule and the dye molecule are arranged substantially in parallel with the extension direction, thereby forming the polarizing element 420. The iodine molecules and the dye molecules are dichroic, so that the light vibrating in the extension direction is absorbed and the light vibrating in the direction substantially in perpendicular to the extension direction passes through the polarizing element 420.

The polarizing element 420 has week mechanical strength in the direction of the polarizing axis, and easily shrinks by heat or moisture. Therefore, the first protective layer 430 and the second protective layer 440 are formed on both sides of the polarizing element 420 to increase the strength and to prevent the shrinkage. The first protective layer 430 and the second protective layer 440 are attached to both sides of the polarizing element 420, respectively.

The first protective layer 430 and the protective layer 440 include tri-acetyl cellulose (TAC) film. The first protective layer 430 and the second protective layer 440 improve thermal endurance and the mechanical strength. Moreover, the first protective layer 430 and the second protective layer 440 may absorb ultra-violet light damaging the liquid crystal.

The surface treatment layer 410 prevents dazzling on the exposed surface of the first protective layer 430. The surface treatment layer 410 includes at least two kinds of scattering materials having different refractive indexes so that the haze value of the surface treatment layer 410 is increased. The surface treatment layer 410 is formed by coating a polymer resin film onto the first protective layer 430. At least two kinds of the scattering materials are dispersed in the polymer resin film. For example, the polymer resin film may include acrylate resin.

The scattering materials include a scattering particle 412 and an air bubble 414. The scattering particle 412 has a first refractive index, and the air bubble has a second refractive index. The air bubble 414 surrounds the scattering particle 412. Thereby, the surface treatment layer 410 has two kinds of scattering materials having different refractive indexes, so that the haze value is increased although the density of the scattering materials is decreased.

The scattering particle 412 includes a polymer resin having the refractive index substantially the same as the polymer resin film. For example, the scattering particle 412 may include silica, and a size of the scattering particle is in a range of about 3 μm to about 5 μm.

A thickness of the surface treatment layer 410 may be in a range of about 4 μm to about 6 μm. The scattering particle 412 having the size in a range of about 3 μm to about 5 μm is dispersed in the polymer resin film at a low density, so that the surface roughness of the surface treatment layer 410 is improved.

The inside haze value by the scattering materials of the surface treatment layer 410 is changed according to the size and the density of the scattering particle 412 and the air bubble 414. The outside haze value recognized at the surface of the surface treatment layer 410 is decided by the surface roughness.

Table 1 represents a relationship between dazzling, the inside haze value and the outside haze value of the surface treatment layer.

TABLE 1

| Inside haze value (%) | Outside haze value (%) | Dazzling |
|---|---|---|
| 5 | 0.5 | Strong |
| 8 | 0.5 | Strong |
| 12 | 0.5 | Strong |
| 15 | 0.5 | Strong |
| 18 | 0.5 | Week |
| 21 | 0.5 | Slightly week |
| 25 | 0.5 | None |
| 28 | 0.5 | None |
| 35 | 0.5 | None |

In Table 1, the outside haze value was fixed at about 0.5% level to reduce a change of a gray-scale from a black color to a gray color by the scattering at the surface of the surface treatment layer and to enhance a glare effect. The dazzling was tested by changing the inside haze value.

Referring to Table 1, when the outside haze was fixed at about 0.5% and the inside haze is more than about 25%, the dazzling was not detected. Therefore, the surface treatment layer 410 may be formed at more than about 25% level. However, when the inside haze value was too high, the brightness was reduced, so that the inside haze value was formed between about 25% to 50%.

As mentioned above, the inside haze value of the surface treatment layer 410 is changed according to the size and the density of the scattering materials. The scattering particle 412 and the air bubble 414 having the different refractive indexes from each other are formed simultaneously, so that the density of the scattering materials may reduce.

With the density of the scattering materials reduced, the surface roughness of the surface treatment layer 410 is improved and the outside haze value is reduced. The outside haze value may be less than about 1% to minimize scattering of light at the surface of the surface treatment layer 410. However, when the outside haze value is less than about 0.1%, the reflection at the surface is increased and the quality of the display is deteriorated.

Therefore, the surface treatment layer 410 may be formed in a range of about 0.1% to about 1%. The scattering of the light is minimized by decreasing the outside haze value, so that the color reproducibility may improve.

Moreover, the density of the scattering materials is decreased so that the surface roughness of the surface treatment layer 410 is improved. The surface hardness of the surface treatment layer 410 may be increased at about 4H level of pencil hardness.

The first polarizer 300 of FIG. 1 is substantially the same as the second polarizer 400 except for the surface treatment layer 410.

FIG. 3 is a cross-sectional view illustrating a second polarizer in accordance with an exemplary embodiment of the present invention. The second polarizer 500 of FIG. 3 is the same as in FIG. 2 except for the surface treatment layer.

Referring to FIG. 3, a surface treatment layer 550 is formed on a first protective layer 530. A first scattering material 552 and a second scattering material 554 having different refractive indexes from each other are formed and separated from each other in the surface treatment layer 550. For example, the first scattering material 552 may include silica, and the second scattering material 554 may include an air bubble having less refractive index than the first scattering material 552. The size of the second scattering material 554 having the air bubble is smaller than the first scattering material 552 having silica. The second scattering materials 554 are distributed evenly between the first scattering materials 552.

The second scattering material 554 may be formed from the polymer material having less refractive index than the silica.

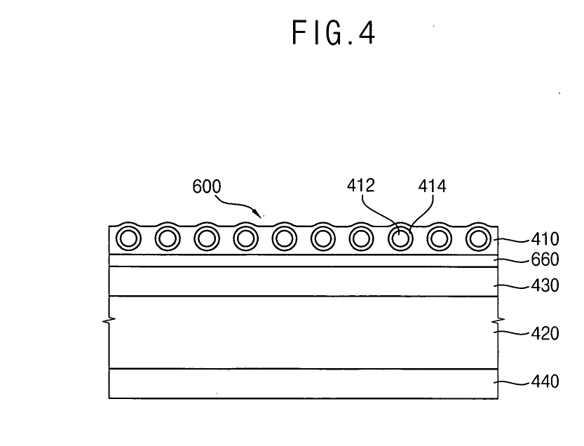

FIG. 4 is a cross-sectional view illustrating a second polarizer in accordance with an exemplary embodiment of the present invention. The second polarizer 600 of FIG. 4 is the same as in FIG. 2 except for the electrostatic preventive layer. Thus, the same reference numerals will be used to refer to the same or like parts as those described in FIG. 2.

Referring to FIG. 4, the second polarizer 600 may further include an electrostatic preventive layer 660 to prevent image quality deterioration caused by electromagnetic waves and electrostatics inflowing from outside.

The electrostatic preventive layer 660 is formed between the first protective layer 430 and the surface treatment layer 410. The electrostatic preventive layer 660 also may be formed between the polarizing element 420 and the first protective layer 430.

The electrostatic preventive layer 660 includes organic material having metallic powder. For example, the electrostatic preventive layer 660 may include antimony tin oxide (ATO) or indium tin oxide (ITO).

The electrostatic preventive layer 660 reduces the electromagnetic wave and dissipates the electrostatic charge, so that the display deterioration such as blot or moire is improved.

According to a polarizer and a display apparatus having the polarizer, at least two kinds of scattering materials having different refractive indexes are applied to a surface treatment layer, so that an inside haze value is increased although the density of the scattering materials is decreased. Thus, dazzling may decrease.

Moreover, an outside haze value of the surface treatment layer is decreased, so that color reproducibility may improve.

Moreover, a surface roughness of the surface treatment layer is improved, so that a surface hardness is improved to be about 4H level of pencil hardness.

Although the exemplary embodiments of the present invention have been described herein with reference to the accompanying drawings, it is to be understood that the present invention should not be limited to those precise exemplary embodiments and that various other changes and modifications may be affected therein by one of ordinary skill in the related art without departing from the spirit or scope of the present invention. All such changes and modifications are intended to be included within the scope of the invention as defined by the appended claims.

What is claimed is:

1. A polarizer comprises:
a polarizing element;
a first protective layer formed on a first side and a second protective layer formed on a second side opposite the first side of the polarizing element,; and
a surface treatment layer formed on the first protective layer and the surface treatment layer including at least two kinds of scattering materials having different refractive indexes from each other.

2. The polarizer of claim 1, wherein an inside haze value by the scattering materials is in a range of about 25% to about 50%.

3. The polarizer of claim 2, wherein an outside haze value at a surface of the surface treatment layer is in a range of about 0.1% to about 1%.

4. The polarizer of claim 1, wherein the scattering materials comprise scattering particles having a first refractive index and air bubbles having a second refractive index smaller than the first refractive index.

5. The polarizer of claim 4, wherein each of the air bubbles surrounds each of the scattering particles.

6. The polarizer of claim 4, wherein the scattering particles comprise silica.

7. The polarizer of claim 4, wherein a size of each of the scattering particles is in a range of about 3 μm to about 5 μm.

8. The polarizer of claim 1, wherein a thickness of the surface treatment layer is in a range of about 4 μm to about 6 μm.

9. The polarizer of claim 1, wherein the first and second protective layers comprise tri-acetyl cellulose (TAC) film.

10. The polarizer of claim 1, further comprising an electrostatic protective layer formed between the first protective layer and the surface treatment layer.

11. A display apparatus comprising:
a display panel including a first substrate, a second substrate facing the first substrate and a liquid crystal layer disposed between the first substrate and the second substrate;
a first polarizer disposed on an outer surface of the first substrate; and
a second polarizer disposed on an outer surface of the second substrate and including at least two kinds of scattering materials having different refractive indexes from each other.

12. The display apparatus of claim 11, wherein the second polarizer comprises a second polarizing element, and first and second protective layers formed at both sides of the second polarizing element,
and the surface treatment layer is formed on the first protective layer.

13. The display apparatus of claim 12, wherein an inside haze value of the second polarizer is in a range of about 25% to about 50%.

14. The display apparatus of claim 13, wherein an outside haze value at a surface of the surface treatment layer is in a range of about 0.1% to about 1%.

15. The display apparatus of claim 12, wherein the scattering materials comprise scattering particles having a first refractive index and air bubbles having a second refractive index smaller than the first refractive index.

16. The display apparatus of claim 15, wherein each of the air bubbles surrounds each of the scattering particles.

17. The display apparatus of claim 15, wherein a size of each of the scattering particles is in a range of about 3 μm to about 5 μm.

18. The display apparatus of claim 12, wherein the first polarizer comprises a first polarizing element and a third and a forth protective layers are formed at opposing sides of the first polarizing element.

19. The display apparatus of claim 11, wherein the first substrate comprises a thin film transistor substrate including a thin film transistor array and a pixel electrode, and the second substrate comprises a color filter substrate including a color filter and a common electrode.
